(19) United States
(12) Patent Application Publication
(10) Pub. No.: US 2010/0143237 A1
(43) Pub. Date: Jun. 10, 2010

(54) A Method of Treating Potash

(75) Inventors: Raymond Walter Shaw, Princes Hill (AU); Robin John Batterham, Parkville (AU)

Correspondence Address: BAKER & MCKENZIE LLP, 711 Louisiana, Suite 3400, HOUSTON, TX, 77002, US

(73) Assignee: Potasio Rio Colorado S.A., Buenos Aires (AR)

(21) Appl. No.: 12/530,427

(22) PCT Filed: Mar. 6, 2008
(86) PCT No.: PCT/AU2008/000313

§ 371 Date: Feb. 23, 2010

(30) Foreign Application Priority Data
Mar. 6, 2007 (AU) 2007901152

(51) Int. Cl. C01D 3/04; C01F 5/30

(52) U.S. Cl. 423/497; 423/499.4

(57) ABSTRACT

A method of separating potassium chloride and sodium chloride from a heated solution of these salts, such as a solution obtained from potash ore, to recover potassium chloride from the ore is disclosed. The method includes a combination of steps of (a) extracting water from a heated solution containing potassium chloride and sodium chloride using a membrane system and (b) subsequently cooling the solution discharged from the membrane system, whereby steps (a) and (b) make it possible to selectively recover potassium chloride and sodium chloride from the solution.

The present invention relates to a method of separating potassium chloride and sodium chloride from a heated solution of these salts.

The present invention relates particularly, although by no means exclusively, to treating potash ore, such as ore containing potash minerals such as sylvinite (a mixture of sylvite (KCl) and rock salt (NaCl)) to recover potassium chloride from the ore.

The dissolution-crystallisation (or hot leaching) process is one known process for recovering potassium chloride from potash ores.

In the dissolution-crystallisation process, potash ore is crushed and washed, clay is removed from the washed ore, and the resultant clarified solution is heated, thereby dissolving potassium chloride and sodium chloride from the washed ore.

One downstream processing option in the dissolution-crystallisation process includes evaporating water from the heated solution and thereby causing precipitation of potassium chloride and sodium chloride from solution. The precipitated potassium chloride and sodium chloride are then separated from each other in a subsequent flotation step.

Another downstream processing option takes advantage of the fact that potassium chloride is very much more soluble in hot water than in cold water, whereas sodium chloride is only slightly more soluble in hot water (for example water at 100° C.) than in cold water (for example water at 20° C.). Consequently, in solutions saturated with respect to both potassium chloride and sodium chloride, sodium chloride is less soluble at higher temperatures.

This other downstream processing option includes precipitating sodium chloride selectively during evaporation by limiting the extent of evaporation—taking advantage of the lower solubility of sodium chloride compared to potassium chloride at higher temperatures—and after separating precipitated sodium chloride from the solution, cooling the solution and precipitating potassium chloride from the solution—taking advantage of the lower solubility of potassium chloride at lower temperatures than at higher temperatures.

In both of the above processing options, the evaporated water is lost, and this is undesirable.

In addition, in both of the above processing options there are high energy costs associated with heating process solutions, and this is undesirable.

The above discussion is not to be taken as an admission of the common general knowledge in Australia and elsewhere.

An object of the present invention is to provide another process for recovering potassium chloride from a source of potassium chloride such as a potash ore that does not include removing water completely from the process streams using water evaporation steps and thereby avoids loss of water from the process by evaporation.

The present invention is based on a realization that a combination of (a) extracting water from a heated solution containing potassium chloride and sodium chloride using a membrane system and (b) subsequently cooling the solution discharged from the membrane system is an effective method of recovering potassium chloride and sodium chloride from the solution.

In general terms, the present invention is a method of separating potassium chloride and sodium chloride from a heated solution of these salts that includes a combination of steps of (a) extracting water from a heated solution containing potassium chloride and sodium chloride using a membrane system and (b) subsequently cooling the solution discharged from the membrane system, whereby steps (a) and (b) make it possible to selectively recover potassium chloride and sodium chloride from the solution. Accordingly, in general terms, the method also includes selectively recovering potassium chloride and sodium chloride from the solution.

According to the present invention there is provided a method of separating potassium chloride and sodium chloride from a heated solution of these salts includes the steps of:
(a) forming a heated solution containing potassium chloride and sodium chloride derived from a potash ore;
(b) passing the solution through a membrane system and removing water from the solution and thereby increasing the concentration of sodium chloride in the solution above the solubility of the salt at the temperature of the solution and precipitating sodium chloride from the solution;
(c) separating the precipitated sodium chloride from the solution;
(d) cooling the solution and thereby decreasing the solubility of potassium chloride below the concentration of potassium chloride in the solution and thereby precipitating potassium chloride from the solution; and
(e) separating potassium chloride from the solution.

The above-described membrane system removes water other than by evaporation and is advantageous on this basis. Moreover, the removed water is available for use in other process steps.

Step (a) of forming the heated solution containing potassium chloride and sodium chloride may include forming the solution by dissolving mined ores from an ore body containing minerals that contain potassium chloride and sodium chloride, such as potash ore, above ground or via solution mining involving injecting heated water or a heated solution that is unsaturated with respect to potassium chloride and sodium chloride into an ore body, such as a potash ore body, and dissolving the ore underground.

The ore body may contain other materials that are taken into solution into the heated solution and can be beneficially processed in step (b) using the membrane system.

For example, in situations where the ore body and thereafter the heated solution contains significant amounts, even to saturation levels, of magnesium chloride, as may be the case when there is carnallite (KMgCl₃.6(H₂O)) present in or with the potash ore, the membrane system may facilitate concentrating up the solution and precipitating magnesium chloride in downstream method steps.

In such situations, the method may include the steps of precipitating and thereafter separating precipitated magnesium chloride from the solution.

Preferably step (a) includes forming the solution at a temperature of at least 50° C.

More preferably, step (a) includes forming the solution at a temperature of at least 60° C.

It is preferred particularly that step (a) includes forming the solution at a temperature of at least 70° C.

Preferably step (a) includes forming the solution at a temperature of less than 90° C.

More preferably step (a) includes forming the solution at a temperature of less than 80° C.

Preferably step (b) includes controlling water removal from the solution to control water removal to precipitate sodium chloride crystals of a selected size.

The membrane system may be any suitable system.

For example, the membrane system may be a hydrophilic or osmosis system which relies on pressure to transfer water between solutions either under forced pressure such as in reverse osmosis or by taking advantage or osmotic pressure differences due to different salt concentrations such as in normal osmosis.

The membrane system may also be a hydrophobic system which relies on vapor pressure differences resulting primarily from temperature differences to remove water from the solution or to transfer water between solutions using a process termed “membrane distillation”.

The membrane system may also be a combination of hydrophobic and hydrophilic membranes whereby water is transferred from the solution by both membrane distillation and osmosis.

Preferably the method includes recycling the remaining solution after the potassium chloride separation step (e) to the method.

Preferably the method includes heating the remaining solution prior to recycling the solution to the method.

Preferably the method includes heating the remaining solution prior to recycling the solution to the method by heat exchange with the solution supplied to step (d) and thereby cooling the solution to precipitate potassium chloride.

Preferably the method includes combining (i) the remaining solution after the potassium chloride separation step (e) and (ii) water removed from the solution in step (b), heating the combined solution, and using the heated combined solution in step (a) and forming the heated solution containing potassium chloride and sodium chloride.

The present invention is described further by way of example with reference to the accompanying drawings, of which:

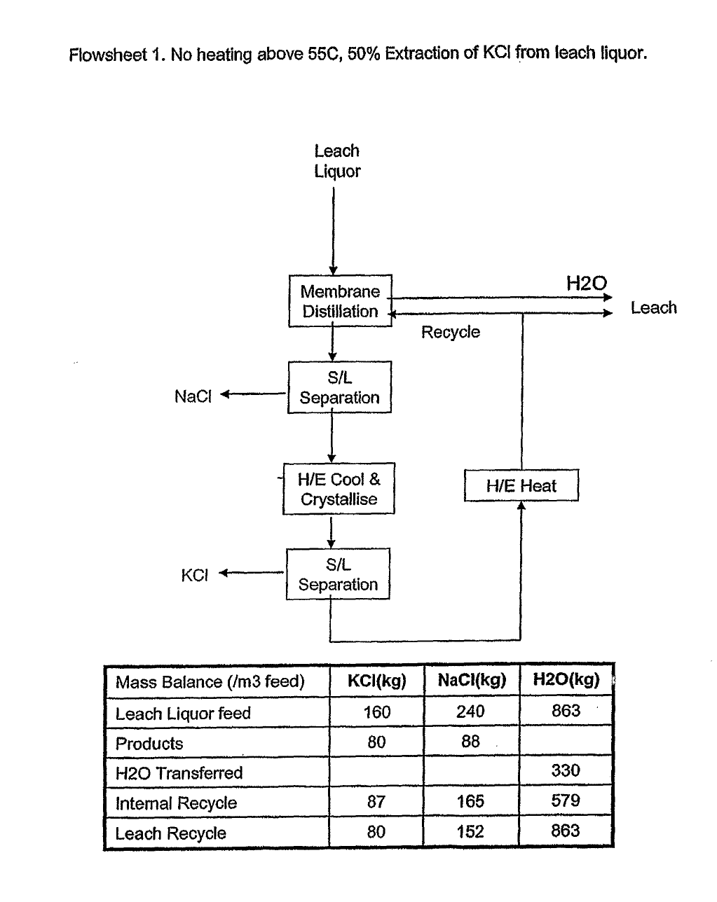

FIG. 1 is a flowsheet of one embodiment of the method of treating potash ore to recover potassium chloride from the ore in accordance with the present invention;

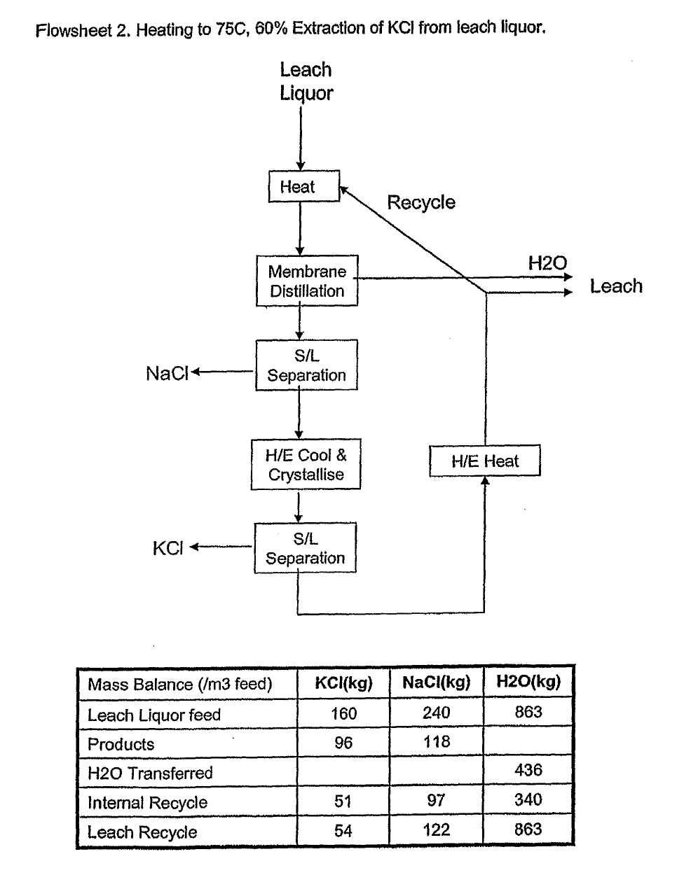

FIG. 2 is a flowsheet of another embodiment of the method of treating potash ore to recover potassium chloride from the ore in accordance with the present invention; and

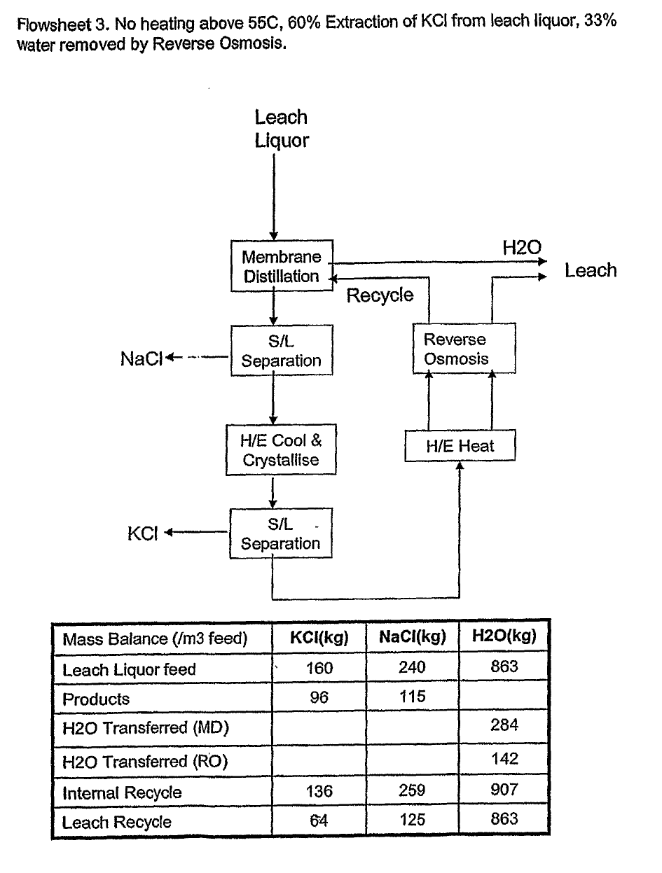

FIG. 3 is a flowsheet of another embodiment of the method of treating potash ore to recover potassium chloride from the ore in accordance with the present invention.

With reference to FIG. 1, a feed solution (referred to as a “Leach Liquor” in the flowsheet) at a temperature of no more than 55° C. that is saturated or nearly saturated with respect to potassium chloride and sodium chloride is supplied to a hydrophobic membrane system (referred to as “Membrane Distillation” in the flowsheet), whereby water is removed from the solution as the solution passes through the membrane.

The membrane system may be any suitable system that enables water transfer from the solution either by membrane distillation or by forward or reverse osmosis. Such water transfer does not involve evaporation of water.

The removal of water from the solution increases the concentration of sodium chloride in the solution above the solubility limit of sodium chloride at that temperature, with a result that sodium chloride precipitates from the solution.

The amount of water removal is controlled so that preferably the concentration of potassium chloride in the solution does not exceed the solubility limit of potassium chloride at the temperature. Accordingly, the step is controlled to selectively precipitate sodium chloride rather than potassium chloride.

The amount of precipitation depends on a range of factors, including the initial concentration of sodium chloride in the solution, the solution temperature, the amount of water removed from the solution, and the residence time of the solution in the membrane system.

The precipitation of the sodium chloride may be deliberately controlled to give crystals of a reasonably uniform size and shape by taking advantage of the process termed “membrane crystallization” which is possible using membrane systems of this type.

Alternatively, the precipitation may be largely uncontrolled if these properties are not important in the subsequent separation and marketing of the sodium chloride.

The solution containing precipitated sodium chloride from the membrane system is supplied to a solid/liquid separator (referred to as “S/L Separation” in the flowsheet) and precipitated sodium chloride is separated from the solution in the separator.

The separator may be any suitable solids/liquid separation unit.

The precipitated sodium chloride discharged from the solid/liquid separator is processed further as may be required.

The remaining solution discharged from the solid/liquid separator is transferred to a heat exchanger (referred to as “H/E Cool & Crystallise” in the flowsheet) and is cooled as it passes through the heat exchanger, thereby reducing the solubility of potassium chloride in the solution below the concentration of the potassium chloride in the solution and thereby precipitating potassium chloride from the solution.

By way of example, the heat exchanger may include a vacuum distillation step for removal of additional water and to provide some cooling, albeit the extent to which this can be done is limited by the need to avoid excessive sodium chloride precipitation if this causes contamination which lowers the value of the potassium chloride.

The heat exchanger may be any suitable heat exchanger.

The precipitated potassium chloride is separated from the solution in a down-stream solid/liquid separator (referred to as “S/L Separation” in the flowsheet), thereby completing the recovery of potassium chloride from the potash ore.

The separator may be any suitable solids/liquid separation unit.

The precipitated potassium chloride is processed further as may be required.

The remaining solution discharged from the solids/liquids separator, which still contains potassium chloride and sodium chloride, albeit at lower concentrations than the initial feed solution, is supplied to a heat exchanger (referred to as “H/E Heat” in the flowsheet) and heated therein. The heat exchanger may be any suitable heat exchanger. Advantageously, the heat exchanger is the heat exchanger used to cool the above-described solution containing potassium chloride from the 1^{st} S/L Separation step.

At least a part of the heated solution is then recycled to the membrane system and is used beneficially to maintain the temperature in the membrane system.

The main drivers for the flowsheet are the need to keep a reasonably high temperature in the membrane system to avoid precipitation of potassium chloride and a desire to minimise total energy usage.

The flowsheet shown in FIG. 2 is substantially the same as the FIG. 1 flowsheet.

The main differences between the flowsheets are discussed below.
1. The FIG. 2 flowsheet operates at a higher temperature of up to 75° C. for the feed solution.
2. The higher temperature of the feed solution makes it possible to extract a higher concentration of potassium chloride—cf 60% versus 50%.
3. The higher temperature of the feed solution makes it possible to recycle the solution remaining after the potassium chloride separation step at a higher temperature and makes it possible to use the heat of the solution to contribute to heating the feed solution. This is shown in the FIG. 2 flowsheet by the recycle line supplying at least a part of the recycle solution to a heating step upstream of the membrane system.

The flowsheet shown in FIG. 3 is substantially the same as the FIG. 1 flowsheet.

The main difference between the two flowsheets is that in the FIG. 3 flowsheet the heated solution remaining after the potassium chloride separation step and the subsequent heat exchange step is supplied to a second membrane system (referred to as “Reverse Osmosis” in the figure) and further water, typically 33%, is removed from the solution in the membrane system.

This reverse osmosis step is possible because both solutions initially have the same salt concentration, and hence osmotic pressure, and although this osmotic pressure is quite high and above that which would allow transfer of the water into a pure water stream such as is done in desalination processes, the pressure required to drive the water from one solution to the other is not excessive when both have significant levels of salt present until a significant portion of the water has been transferred from the solution, as occurs in the first membrane system (“Membrane Distillation” in the figure).

Many modifications may be made to the embodiments of the present invention described above without departing from the spirit and scope of the invention.

By way of example, whilst the above-described embodiments operate with feed solutions at temperatures of up to 50 and 75° C., the present invention is not so limited and extends to feed solutions at any suitable temperatures.

By way of further example, whilst the above-described embodiments achieve recoveries of 50 and 60% potassium chloride, the present invention is not so limited to these recoveries.

1. A method of separating potassium chloride and sodium chloride from a heated solution of these salts including the steps of:
(a) forming a heated solution containing potassium chloride and sodium chloride derived from a suitable source;
(b) passing the solution through a membrane system and removing water from the solution and thereby increasing the concentration of sodium chloride in the solution above the solubility of the salt at the temperature of the solution and precipitating sodium chloride from the solution;
(c) separating the precipitated sodium chloride from the solution;
(d) cooling the solution and thereby decreasing the solubility of potassium chloride below the concentration of potassium chloride in the solution and thereby precipitating potassium chloride from the solution; and
(e) separating potassium chloride from the solution.

2. The method of claim 1, wherein step (a) of forming the heated solution containing potassium chloride and sodium chloride includes forming the solution by dissolving mined potash ore above ground or via solution mining involving injecting heated water or a heated solution that is unsaturated with respect to potassium chloride and sodium chloride into a potash ore body and dissolving the ore underground.

3. The method of claim 1, wherein step (a) includes forming the solution at a temperature of at least 50° C.

4. The method of claim 3, wherein step (a) includes forming the solution at a temperature of at least 60° C.

5. The method of claim 1, wherein step (a) includes forming the solution at a temperature of less than 90° C.

6. The method of claim 5, wherein step (a) includes forming the solution at a temperature of less than 80° C.

7. The method of claim 1, wherein step (b) includes controlling water removal from the solution to control water removal to precipitate sodium chloride crystals of a selected size.

8. The method of claim 1, including recycling the remaining solution after the potassium chloride separation step (e) to the method.

9. The method of claim 8, including heating the remaining solution prior to recycling the solution to the method.

10. The method of claim 8, including heating the remaining solution prior to recycling the solution to the method by heat exchange with the solution supplied to step (d) and thereby cooling the solution to precipitate potassium chloride.

11. The method of claim 1, including combining (i) the remaining solution after the potassium chloride separation step (e) and (ii) water removed from the solution in step (b), heating the combined solution, and using the heated combined solution in step (a) and forming the heated solution containing potassium chloride and sodium chloride.

12. A method of separating potassium chloride and sodium chloride from a heated solution of these salts that includes a combination of steps of (a) extracting water from a heated solution containing potassium chloride and sodium chloride using a membrane system and (b) subsequently cooling the solution discharged from the membrane system, whereby steps (a) and (b) make it possible to selectively recover potassium chloride and sodium chloride from the solution.

13. The method of claim 12, further including selectively recovering potassium chloride and sodium chloride from the solution.

14. A method of separating potassium chloride, sodium chloride and magnesium chloride from a heated solution of these salts that includes a combination of steps of (a) extracting water from a heated solution containing potassium chloride, sodium chloride and magnesium chloride using a membrane system and (b) subsequently cooling the solution discharged from the membrane system, whereby steps (a) and (b) make it possible to selectively recover potassium chloride, sodium chloride and magnesium chloride from the solution.

15. The method of claim 14, further including selectively recovering potassium chloride, sodium chloride and magnesium chloride from the solution.
